(19) United States
(12) Patent Application Publication
(10) Pub. No.: US 2026/0064045 A1
(43) Pub. Date: Mar. 5, 2026

(54) CLEANING DEVICE AND IMAGE FORMING APPARATUS

(71) Applicant: Yoshiki HOZUMI, Kanagawa (JP)

(72) Inventor: Yoshiki HOZUMI, Kanagawa (JP)

(73) Assignee: Ricoh Company, Ltd., Tokyo (JP)

(21) Appl. No.: 19/279,600

(22) Filed: Jul. 24, 2025

(30) Foreign Application Priority Data
Sep. 3, 2024 (JP) 2024-151500

(51) Int. Cl. G03G 15/16; G03G 21/12

(52) U.S. Cl. CPC G03G 15/161; G03G 21/12

(57) ABSTRACT

A cleaning device includes a cleaning member, a seal, a conveyor, a stirrer, and a contact stopper. The cleaning member contacts a target surface of a target moving in a first direction at a first position and removes foreign substances from the target surface to clean the target surface. The seal contacts the target surface at a second position upstream from the first position in the first direction. The conveyor conveys the foreign substances outside the cleaning device. The stirrer stirs the foreign substances removed from the target surface. The contact stopper is disposed between the stirrer and the target surface in a second direction intersecting the first direction to restrict contact between the stirrer and the target surface.

### CROSS-REFERENCE TO RELATED APPLICATION

This patent application is based on and claims priority pursuant to 35 U.S. C. § 119(a) to Japanese Patent Application No. 2024-151500, filed on Sep. 3, 2024, in the Japan Patent Office, the entire disclosure of which is hereby incorporated by reference herein.

### BACKGROUND

### Technical Field

The present disclosure relates to a cleaning device and an image forming apparatus incorporating the cleaning device.

### Related Art

As an image forming apparatus such as a copying machine or a printer, an electrophotographic image forming apparatus is known that a toner image is formed on a surface of an image bearer and the toner image on the image bearer is transferred onto a recording medium such as a sheet.

### SUMMARY

The present disclosure described herein provides a cleaning device that includes a cleaning member, a seal, a conveyor, a stirrer, and a contact stopper. The cleaning member contacts a target surface of a target moving in a first direction at a first position and removes foreign substances from the target surface to clean the target surface. The seal contacts the target surface at a second position upstream from the first position in the first direction. The conveyor conveys the foreign substances outside the cleaning device. The stirrer stirs the foreign substances removed from the target surface. The contact stopper is disposed between the stirrer and the target surface in a second direction intersecting the first direction to restrict contact between the stirrer and the target surface.

The present disclosure described herein also provides an image forming apparatus that includes the cleaning device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an image forming apparatus according to an embodiment of the present disclosure;

FIG. 2 is a schematic view of a belt cleaner of the image forming apparatus of FIG. 1;

FIG. 3 is a perspective view of a stirrer;

FIG. 4 is a perspective view of a stirrer and a conveying screw, which are arranged side by side;

FIG. 5 is a perspective view of a contact stopper; and

FIG. 6 is a schematic view of a belt cleaner according to a comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. In the drawings for illustrating embodiments of the present disclosure, identical or similar reference signs are assigned to elements such as components and parts that have identical or similar functions or shapes as far as distinguishable, and descriptions of such elements may be omitted once the description is provided. As used herein, the singular forms “a,” “an,” and “the” are intended to include the plural forms as well, unless the context clearly indicates otherwise.

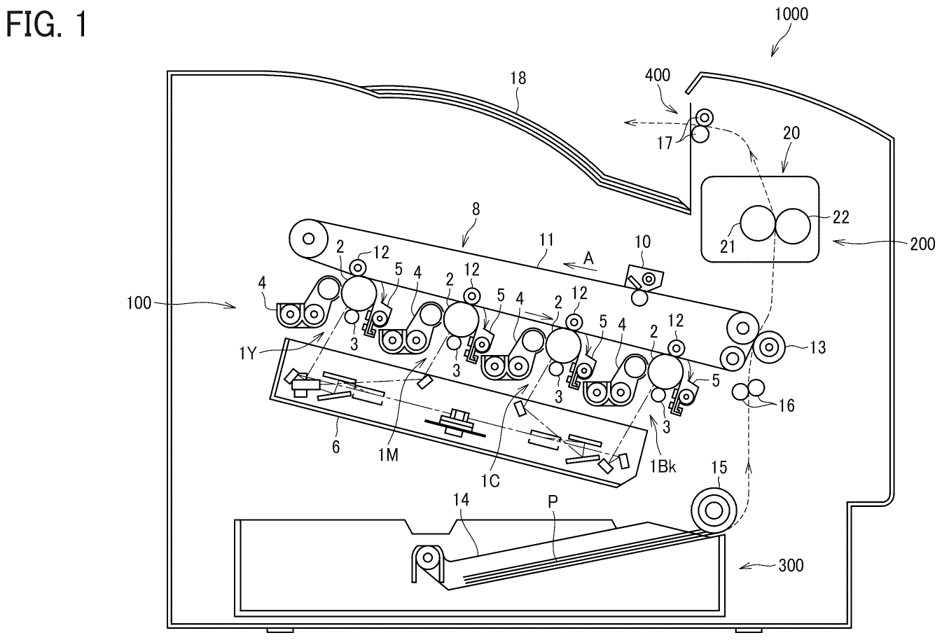

First, with reference to FIG. 1, a description is given of an image forming apparatus according to an embodiment of the present disclosure.

An image forming apparatus 1000 illustrated in FIG. 1 is an electrophotographic image forming apparatus that forms an image using toner as developer. The “image forming apparatus” according to an embodiment of the present disclosure includes a printer, a copier, a facsimile machine, a printing machine, and a multifunction peripheral combining two or more of thereof. The term “image formation” includes the formation of images with meanings such as characters and figures and the formation of images with no meanings such as patterns.

As illustrated in FIG. 1, the image forming apparatus 1000 according to the embodiment of the present disclosure includes an image forming device 100, a fixing unit 200, a sheet supplying device 300, and a sheet ejection device 400.

The image forming device 100 includes four image forming units 1Y, 1M, 1C, and 1Bk, an exposure device 6, and a transfer device 8.

The four image forming units 1Y, 1M, 1C, and 1Bk have basically the same configuration. Specifically, each of the image forming units 1Y, 1M, 1C, and 1Bk includes a photoconductor 2, a charger 3, a developing device 4, and a photoconductor cleaner 5.

The photoconductor 2 is, for example, a drum-shaped member that is driven to rotate, and is an example of an electrostatic latent image bearer or an image bearer that bears an electrostatic latent image or a toner image on the surface (outer circumferential surface). The photoconductor 2 may be a drum-shaped member or an endless belt that is wound around a plurality of rollers and driven to rotate.

The charger 3 is formed of a conductive or semiconductive charging roller that applies a voltage to the surface of the photoconductor 2 to uniformly charge the surface of the photoconductor 2. The charger 3 is not particularly limited as long as the charger 3 can charge the surface of the photoconductor 2, and may be a contact type charger such as a magnetic brush, a fur brush, a film, or a rubber blade, or may be a non-contact type charger using corona discharge.

The developing device 4 includes, for example, a developing roller that supplies toner as developer to the surface of the photoconductor 2. In this case, the developing devices 4 of the image forming units 1Y, 1M, 1C, and 1Bk contain toners of different colors such as yellow, magenta, cyan, and black, and the toners of different colors are supplied to the photoconductors 2 of the developing devices 4.

The photoconductor cleaner 5 includes, for example, a cleaning blade as a cleaning member that removes toner and other foreign substances remaining on the surface of the photoconductor 2. The cleaning member may be a brush roller that rotates while being in contact with the surface of the photoconductor 2.

The exposure device 6 includes an optical system that irradiates the surface of the photoconductor 2 with laser light. Examples of the optical system include a copying optical system, a rod lens array system, a laser optical system, a liquid crystal shutter optical system, and a light-emitting diode (LED) optical system.

The transfer device 8 includes an intermediate transfer belt 11, a primary transfer roller 12, a secondary transfer roller 13, and a belt cleaner 10.

The intermediate transfer belt 11 is an endless belt and is wound around and supported by a plurality of rollers including the primary transfer rollers 12. The intermediate transfer belt 11 is an example of an image bearer that bears a toner image on the surface (outer circumferential surface) of the intermediate transfer belt 11. One of the plurality of rollers supporting the intermediate transfer belt 11 functions as a driving roller, so that the intermediate transfer belt 11 is rotated in a direction indicated by an arrow A of FIG. 1. The belt member forming the intermediate transfer belt 11 may have a single-layer structure or a multi-layer structure. In the case of a multi-layer structure, a base layer made of fluororesin, polyvinylidene fluoride (PVDF), or polyimide resin with low elongation is preferably covered with a coating layer made of a material with good smoothness such as fluororesin. In the case of a single-layer structure, the belt is preferably made of, for example, PVDF, polycarbonate (PC), and polyimide.

Four primary transfer rollers 12 are disposed inside the intermediate transfer belt 11, and are arranged to face the respective photoconductors 2 via the intermediate transfer belt 11. Each of the primary transfer rollers 12 contacts the inner circumferential surface of the intermediate transfer belt 11 at a position facing the corresponding photoconductor 2, so that the intermediate transfer belt 11 contacts the photoconductor 2 to form a primary transfer nip. The primary transfer rollers 12 may be disposed at positions offset from the contact positions (primary transfer nips) between the photoconductors 2 and the intermediate transfer belt 11 toward the downstream side in the rotation direction of the surface of the intermediate transfer belt 11 by a specified distance (for example, 4 mm to 5 mm).

The secondary transfer roller 13 is disposed to face one of the plurality of rollers that support the intermediate transfer belt 11. The secondary transfer roller 13 and the intermediate transfer belt 11 nip the intermediate transfer belt 11 therebetween, so that a secondary transfer nip is formed between the secondary transfer roller 13 and the intermediate transfer belt 11.

The belt cleaner 10 removes toner and other foreign substances remaining on the intermediate transfer belt 11 after the intermediate transfer belt 11 has passed through the secondary transfer nip. For this reason, the belt cleaner 10 is disposed downstream from the secondary transfer nip in the rotation direction of the intermediate transfer belt 11 (the direction indicated by the arrow A) and upstream from the most upstream primary transfer nip in the rotation direction of the intermediate transfer belt 11. A detailed configuration of the belt cleaner 10 is described later.

The fixing unit 200 includes a fixing device 20 that heats a sheet to fix an image on the sheet. The fixing device 20 includes a fixing rotator 21 heated by a heat source such as a heater, and a pressure rotator 22 pressed against the fixing rotator 21 to form a fixing nip.

The sheet supplying device 300 includes a sheet tray 14 that stores sheets P and a feed roller 15 that feeds the sheet P from the sheet tray 14. A “sheet” on which an image is formed is described as a “paper sheet”, but the “sheet” is not limited to paper (paper sheet), and may be an overhead projector (OHP) sheet, a fabric, a metal sheet, a plastic film, a prepreg sheet in which carbon fibers are impregnated with a resin in advance. The “paper sheet” is not limited to plain paper, and may be thick paper, a postcard, an envelope, thin paper, coated paper (such as coated paper and art paper), and tracing paper.

The sheet ejection device 400 includes an ejection roller pair 17 for ejecting the sheets P and an output tray 18 for stacking the ejected sheets P.

With reference to FIG. 1, a description is given of an image forming operation of the image forming apparatus 1000 according to an embodiment of the present disclosure.

When the image forming operation is started, first, toner images are formed in the image forming units 1Y, 1M, 1C, and 1Bk of the image forming device 100. Specifically, the photoconductors 2 of the image forming units 1Y, 1M, 1C, and 1Bk start rotating clockwise in FIG. 1, and the surfaces of the photoconductors 2 are charged to a uniform high potential by the chargers 3. The exposure device 6 exposes the charged surface of each of the photoconductors 2 based on image data of a document read by a document reading device or print data instructed to print by a terminal. As a result, the electric potential at an exposed portion on the surface of each of the photoconductors 2 is decreased. Thus, an electrostatic latent image is formed on the surface of each of the photoconductors 2. Thereafter, toner is supplied from each of the developing devices 4 to each of the photoconductors 2, so that a toner image of each of colors is formed on each of the photoconductors 2.

The toner image formed on the photoconductor 2 reaches a primary transfer nip (the position of the primary transfer roller 12) as the photoconductor 2 rotates. At this time, a primary transfer bias having a polarity opposite to the toner charging polarity of the toner images is applied to the primary transfer rollers 12, so that the toner images on the photoconductors 2 are sequentially transferred to the intermediate transfer belt 11, which is driven to rotate in synchronization with the photoconductor 2, to be superimposed on the intermediate transfer belt 11. Thus, the full-color toner image is formed on the intermediate transfer belt 11. Image formation is not limited to the case where a full-color image is formed using the four image forming units 1Y, 1M, 1C, and 1Bk, and may be a case where a single-color image is formed using any one of the image forming units 1Y, 1M, 1C, and 1Bk, or a case where a two-color image or a three-color image is formed using any two or three of the image forming units 1Y, 1M, 1C, and 1Bk. After the toner image is transferred onto the intermediate transfer belt 11, the surface of each photoconductor 2 is cleaned by the respective photoconductor cleaner 5. As a result, foreign substances such as residual toner are removed from the surface of each photoconductor 2.

The toner image on the intermediate transfer belt 11 transferred as described above is conveyed to the secondary transfer nip (the position of the secondary transfer roller 13) with the rotation of the intermediate transfer belt 11, and is transferred onto the sheet P. The sheet P is fed from the sheet supplying device 300 toward the secondary transfer nip. Specifically, when the image forming operation is started, the feed roller 15 is driven to rotate, so that the sheets P are fed one by one from the sheet tray 14. The sheet P fed by the feed roller 15 abuts against a timing roller pair 16 on the way to the secondary transfer nip, and the conveyance of the sheet P is temporarily stopped. Thereafter, the timing roller pair 16 rotates at a specified timing, so that the sheet P is conveyed to the secondary transfer nip at a timing at which the sheet P can receive the toner image on the intermediate transfer belt 11. At this time, a secondary transfer bias having a polarity opposite to the toner charging polarity of the toner image is applied to the secondary transfer roller 13, so that the toner image is transferred from the intermediate transfer belt 11 onto the sheet P. After the toner image is transferred onto the sheet P, the belt cleaner 10 removes foreign substances such as residual toner from the intermediate transfer belt 11.

Thereafter, the sheet P having passed through the secondary transfer nip is conveyed to the fixing unit 200 and enters the fixing nip between the fixing rotator 21 and the pressure rotator 22. As a result, the unfixed toner image on the sheet P is heated and pressed to be fixed on the sheet P. Then, the sheets P are conveyed to the sheet ejection device 400 and ejected to the outside of the apparatus by the ejection roller pair 17, and thus, stacked on the output tray 18. As described above, a series of image forming operations are completed.

A description is given of a disadvantage in a belt cleaner with reference to a comparative example different from the present disclosure.

FIG. 6 is a schematic view of the belt cleaner according to the comparative example.

As illustrated in FIG. 6, a belt cleaner 90 according to a comparative example includes a cleaning blade 91, a seal 92, a conveying screw 93, and a stirrer 94. The cleaning blade 91 removes foreign substances such as residual toner from the surface of the intermediate transfer belt 11. The seal 92 prevents the removed foreign substances from leaking from the belt cleaner 90. The conveying screw 93 conveys the foreign substances in the belt cleaner 90 toward a collection container. The stirrer 94 stirs the foreign substances in the belt cleaner 90.

The cleaning blade 91 contacts the outer circumferential face of the intermediate transfer belt 11 such that a tip portion 91a of the cleaning blade 91 faces in a direction (counter direction) opposite to a surface moving direction (the direction indicated by the arrow A) of the intermediate transfer belt 11. The seal 92 is disposed such that a tip portion 92a thereof is oriented to the rotation direction of the surface of the intermediate transfer belt 11 and contacts the surface (the outer circumferential surface) of the intermediate transfer belt 11 on an upstream side of the cleaning blade 91 in the surface movement direction of the intermediate transfer belt 11. The conveying screw 93 is stored in a housing 95 of the belt cleaner 90 and is driven to rotate to convey foreign substances in the axial direction. The stirrer 94 contacts the conveying screw 93 that is driven to rotate, so that the stirrer 94 is displaced between a position indicated by a solid line and a position indicated by a dotted line in FIG. 6.

As described above, in the comparative example, the stirrer 94 is displaced in accordance with the rotational driving of the conveying screw 93, so that foreign substances in the housing 95 is stirred, and the aggregation of toner contained in the foreign substances is restricted. Such a configuration can restrict a decrease in the fluidity of the foreign substances due to the aggregation.

When the type of the target surface to be cleaned is changed or the arrangement of the cleaning blade is changed depending on the specification of the belt cleaner, effectively stirring foreign substances stagnating near the target surface may be difficult. In particular, in a case where a sheet containing a large amount of paper dust is used as the recording medium, the amount of paper dust collected from the intermediate transfer belt into the cleaning device increases. Thus, if the foreign substances may not be effectively stirred, the fluidity of the foreign substances decreases, the foreign substances in the belt cleaner may overflow.

In such a case, if the tip portion of the stirrer is extended to the vicinity of the target surface, the foreign substances near the target surface can be effectively stirred. However, if the tip portion of the stirrer is extended to the vicinity of the target surface, the stirrer may contact the target surface and damage the target surface. For example, in the comparative example illustrated in FIG. 6, the surface of the intermediate transfer belt 11 is exposed to the inside of the belt cleaner 90 between the cleaning blade 91 and the seal 92, if a tip portion 94a of the stirrer 94 is extended, the tip portion 94a of the stirrer 94 may contact the surface of the intermediate transfer belt 11 between the cleaning blade 91 and the seal 92.

In the present disclosure, an object is to prevent a stirrer from contacting a target surface in order to prevent the target surface from being damaged. Hereinafter, a description is given of a belt cleaner according to an embodiment of the present disclosure, as an example of a characteristic portion of the present disclosure.

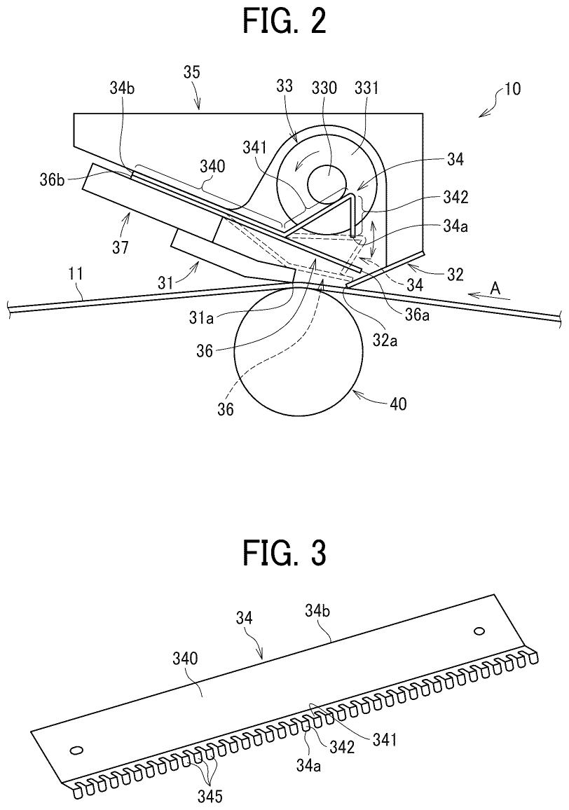

FIG. 2 is a schematic view of a belt cleaner of the image forming apparatus according to an embodiment of the present disclosure.

First, with reference to FIG. 2, a basic configuration of the belt cleaner 10 according to an embodiment of the present disclosure. As illustrated in FIG. 2, the belt cleaner 10 according to the embodiment of the present disclosure includes, as in the comparative example described above, a cleaning blade 31 that removes foreign substances such as residual toner from the surface of the intermediate transfer belt 11, a seal 32 that prevents the removed foreign substances from leaking from the belt cleaner 10, a conveying screw 33 that conveys the foreign substances in the belt cleaner 10 toward a collection container, a stirrer 34 that stirs the foreign substances in the belt cleaner 10, and a housing 35 that stores the conveying screw 33.

The cleaning blade 31 is an example of a cleaning member that contacts the surface of the intermediate transfer belt 11 to clean the surface of the intermediate transfer belt 11. In this case, the cleaning blade 31 is formed in a blade shape made of urethane, but the material and shape of the cleaning blade 31 can be changed as appropriate. As illustrated in FIG. 2, the cleaning blade 31 is held by a cleaning blade holder 37 such that a tip portion 31a of the cleaning blade 31 faces in a direction (counter direction) opposite to a surface moving direction (the direction indicated by the arrow A) of the intermediate transfer belt 11. A cleaning backup roller 40 that supports the tip portion 31a of the cleaning blade 31 is disposed on the side of the inner circumferential surface of the intermediate transfer belt 11 at a position opposite the tip portion 31a of the cleaning blade 31. As described above, when the tip portion 31a of the cleaning blade 31 contacts the surface of the intermediate transfer belt 11 while being supported by the cleaning backup roller 40, and the intermediate transfer belt 11 moves (rotates) in the direction indicated by the arrow A in FIG. 2, foreign substances such as residual toner adhering to the intermediate transfer belt 11 are blocked and removed by the tip portion 31a of the cleaning blade 31.

The seal 32 is disposed to contact the surface (outer circumferential surface) of the intermediate transfer belt 11 at a position on the upstream side of the position where the cleaning blade 31 contacts the surface of the intermediate transfer belt 11 with respect to the surface movement direction of the intermediate transfer belt 11. The seal 32 is fixed to the housing 35 so that a tip portion 32a of the seal 32 faces the surface movement direction of the intermediate transfer belt 11. As described above, the seal 32 contacts the surface of the intermediate transfer belt 11 at a position on the upstream side of the contact portion of the cleaning blade 31. Thus, the foreign substances blocked by the cleaning blade 31 is prevented from leaking from the inside of the housing 35. Although a sheet-like member is used as the seal 32 in the present embodiment, the seal 32 may be a member other than a sheet-like member.

The conveying screw 33 is an example of a conveyor that conveys foreign substances removed from the surface of the intermediate transfer belt 11 to a collection container. In this example, the conveying screw 33 is a screw having a blade portion 331 on the outer circumferential surface of a rotation shaft 330. However, the conveyor may have a shape other than a screw. In the present embodiment of the present disclosure, when the conveying screw 33 rotates, the foreign substances in the housing 35 is conveyed by the blade portion 331 in the axial direction, and the foreign substances is collected in the collection container through a conveyance path disposed in a body of the image forming apparatus 1000.

The stirrer 34 is a member that stirs foreign substances in the housing 35 to enhance the fluidity of the foreign substances. In this case, the stirrer 34 is an elastically deformable sheet-like member bent at a plurality of positions. Specifically, the stirrer 34 includes a fixed portion 340, a first stirring portion 341, and a second stirring portion 342. The fixed portion 340, which is near a rear end 36b of the stirrer 34, is held while being sandwiched between the cleaning blade holder 37 and the housing 35. The first stirring portion 341 extends in a direction approaching the rotation shaft 330 of the conveying screw 33 via a bent portion from a tip portion of the fixed portion 340 or in a direction departing from the intermediate transfer belt 11. The second stirring portion 342 extends in a direction departing from the rotation shaft 330 of the conveying screw 33 via a bent portion from a tip portion of the first stirring portion 341 or in a direction approaching the intermediate transfer belt 11. The first stirring portion 341 and the second stirring portion 342 are displaceable by changing the bending angle of the bent portion or elastically deforming themselves. For this reason, a tip portion 36a portion of the stirrer 34 is a free end.

FIG. 3 is a perspective view of a stirrer according to the embodiment of the present disclosure.

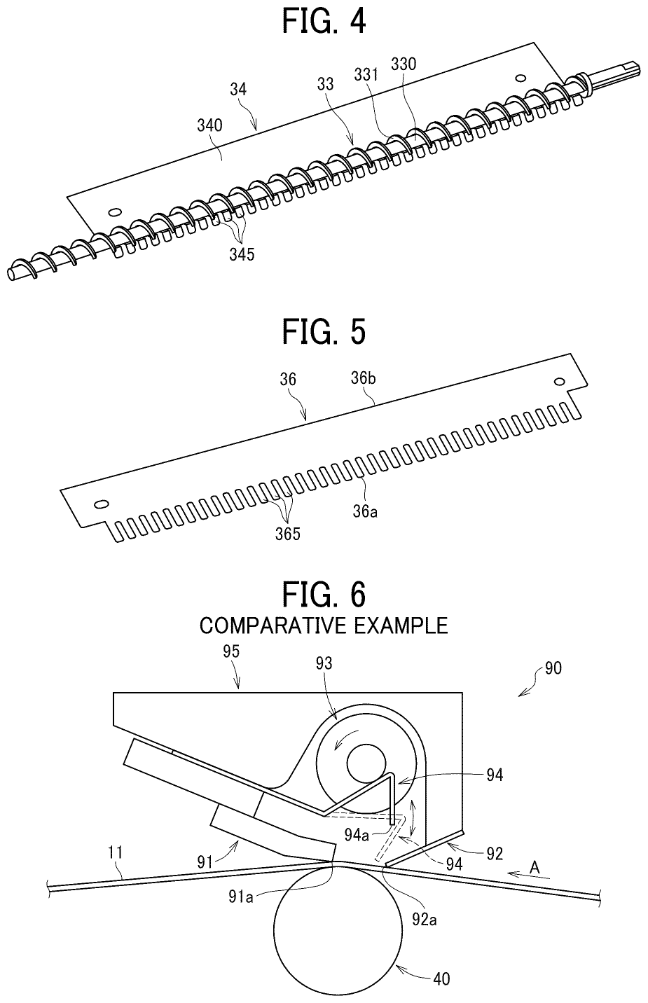

As illustrated in FIG. 3, a plurality of projections 345 have the first stirring portion 341 and the second stirring portion 342 disposed at intervals from each other in the longitudinal direction of the second stirring portion 342. As illustrated in FIG. 4, the plurality of projections 345 are arranged at intervals in the axial direction of the conveying screw 33 (the conveyance direction of the foreign substance) in a state where the stirrer 34 and the conveying screw 33 are assembled. For this reason, when the conveying screw 33 is driven to rotate, alternately contact the rotation shaft 330 and the blade portion 331 of the conveying screw 33 to move the plurality of projections 345. In other words, when the conveying screw 33 is driven to rotate, the rotation shaft 330 and the blade portion 331 are alternately disposed to face the projections 345. Thus, the projections 345 (the first stirring portion 341 illustrated in FIG. 2) are switched between a state of being in contact with the rotation shaft 330 (the state indicated by the solid line in FIG. 2) and a state of being in contact with the blade portion 331 (the state indicated by the dotted line in FIG. 2). Accordingly, the stirrer 34 is displaced between the state indicated by the solid line and the state indicated by the dotted line in FIG. 2. Thus, foreign substances in the housing 35 is stirred by the stirrer 34. The stirrer 34 is not limited to the case where the stirrer 34 is displaced in conjunction with the rotation of the conveying screw 33, and may be displaced by a dedicated driving source.

In the belt cleaner 10 according to the embodiment of the present disclosure, in order to prevent the stirrer 34 that is displaced as described above from contacting the intermediate transfer belt 11, so that a contact stopper 36 that prevents the stirrer 34 from contacting the intermediate transfer belt 11 is disposed (see FIG. 2).

As illustrated in FIG. 2, the contact stopper 36 is attached such that a portion near the rear end 36b is held while being sandwiched between the cleaning blade holder 37 and the housing 35, and the tip portion 36a is a free end. A portion of the contact stopper 36 near the tip portion 36a (a portion extending from the cleaning blade holder 37) is interposed between the stirrer 34 and the intermediate transfer belt 11, and is disposed to cover the surface of the intermediate transfer belt 11 exposed between the cleaning blade 31 and the seal 32.

As described above, in an embodiment of the present disclosure, a portion of the contact stopper 36 near the tip portion 36a is interposed between the stirrer 34 and the intermediate transfer belt 11, and is disposed to cover the surface of the intermediate transfer belt 11 exposed between the stirrer 34 and the intermediate transfer belt 11. Thus, when the stirrer 34 approaches the intermediate transfer belt 11, the contact of the stirrer 34 with the intermediate transfer belt 11 can be prevented. In other words, as illustrated by the dotted line in FIG. 2, when the stirrer 34 is displaced in a direction approaching the intermediate transfer belt 11, a tip portion 34a of the stirrer 34 abuts against the contact stopper 36, so that the contact of the stirrer 34 with the intermediate transfer belt 11 is prevented.

As described above, in the embodiment of the present disclosure, even when the stirrer 34 is displaced with the rotation of the conveying screw 33, the stirrer 34 is prevented from contacting the surface of the intermediate transfer belt 11, so that the intermediate transfer belt 11 can be prevented from being damaged by the stirrer 34 contacting the surface of the intermediate transfer belt 11. Accordingly, in the embodiment of the present disclosure, the function of the intermediate transfer belt 11 can be maintained well. In the embodiment of the present disclosure, the contact of the stirrer 34 with the intermediate transfer belt 11 can be prevented, so that the tip portion 34a of the stirrer 34 can be disposed close to the surface of the intermediate transfer belt 11. With such a configuration, foreign substances stagnating in the vicinity of the surface of the intermediate transfer belt 11 can be effectively stirred, so that flowability of the foreign substances can be enhanced. Thus, the foreign substances can be smoothly conveyed to the collecting container. Even in the case where the sheet containing a large amount of paper powder is used, the paper powder collected from the intermediate transfer belt 11 can be smoothly conveyed, so that occurrence of the image defect due to the paper powder overflowing from the belt cleaner 10 and adhering on the components in the image forming apparatus 1000 can be prevented.

In the embodiment of the present disclosure, the contact stopper 36 is formed of an elastically deformable sheet-like member, and thus, when the tip portion 34a of the stirrer 34 contacts the contact stopper 36, the contact stopper 36 can be bent in a direction approaching the surface of the intermediate transfer belt 11. With such a configuration, in the embodiment of the present disclosure, the tip portion 34a of the stirrer 34 can be brought closer to the intermediate transfer belt 11 than in a configuration in which the contact stopper 36 is not bent. Thus, foreign substances near the front face of the intermediate transfer belt 11 can be effectively stirred.

On the other hand, when the contact stopper 36 is largely bent toward the intermediate transfer belt 11, the contact stopper 36 may contact the surface of the intermediate transfer belt 11. Accordingly, in the embodiment of the present disclosure, as illustrated in FIG. 2, when the contact stopper 36 is bent toward the intermediate transfer belt 11, the contact stopper 36 contacts the cleaning blade 31 and the seal 32. As a result, the contact stopper 36 is supported by the cleaning blade 31 and the seal 32, and the contact stopper 36 is prevented from contacting the surface of the intermediate transfer belt 11, so that the intermediate transfer belt 11 is prevented from being damaged by the contact stopper 36 contacting the surface of the intermediate transfer belt 11. The contact stopper 36 is brought into contact with both the cleaning blade 31 and the seal 32. However, the contact stopper 36 may be brought into contact with one of the cleaning blade 31 and the seal 32 as long as the contact stopper 36 can be prevented from being brought into contact with the intermediate transfer belt 11.

As illustrated in FIG. 5, in the embodiment of the present disclosure, the contact stopper 36 is formed in a shape having a plurality of projections 365 provided at intervals from each other in the longitudinal direction of the contact stopper 36. The projections 365 are arranged at intervals in the axial direction of the conveying screw 33 (in the conveying direction of foreign substance) to face the projections 345 of the stirrer 34, similarly to the projections 345 (see FIGS. 3 and 4) of the stirrer 34. For this reason, when the stirrer 34 is displaced to approach the intermediate transfer belt 11, the respective projections 345 of the stirrer 34 contact the respective projections 365 of the contact stopper 36, so that the stirrer 34 (the respective projections 345) is prevented from contacting the intermediate transfer belt 11. As illustrated in FIG. 5, the contact stopper 36 has gaps between the plurality of projections 365, so that foreign substances near the cleaning blade 31 can be moved toward the conveying screw 33 through the gaps. For this reason, the foreign substances removed by the cleaning blade 31 can be smoothly conveyed by the conveying screw 33, and thus the aggregation of the foreign substances due to the accumulation of the foreign substances on the cleaning blade 31 can be effectively prevented. The distance between the adjacent projections 365 is preferably set to be 1 mm or more, so that foreign substances can be smoothly moved from the cleaning blade 31 to the conveying screw 33. The contact stopper 36 is not limited to the shape illustrated in FIG. 5, and may have other shapes.

Although the embodiments of the present disclosure have been described above, embodiments of the present disclosure are not limited to the above embodiments. For example, the present disclosure is applicable to the belt cleaner 10 that cleans the surface of the intermediate transfer belt 11, and also to the photoconductor cleaner 5 that cleans the surface of the photoconductor 2 as illustrated in FIG. 1.

For example, the present disclosure is not limited to the case where the present disclosure is applicable to the cleaning device that cleans the surface of the image bearer, such as the intermediate transfer belt 11 or the photoconductor 2, that bears an image on the surface of the image bearer, and also to the cleaning device that cleans the surface of the of a member other than the image bearer. Even when the present disclosure is applied to a cleaning device that cleans the surface (target surface) other than the image bearer, the stirrer can be prevented from contacting the target surface as in the above-described embodiment. Thus, the target surface can be prevented from being damaged. The stirrer can be extended to the vicinity of the target surface, so that foreign substances can be effectively stirred.

The above-described embodiments of the present disclosure include at least the following aspects.

### First Aspect

A cleaning device (e.g., the belt cleaner 10) includes a cleaning member (e.g., the cleaning blade 31), a seal (e.g., the seal 32), a conveyor (e.g., the conveying screw 33), a stirrer (e.g., the stirrer 34), and a contact stopper (e.g., the contact stopper 36). The cleaning member contacts a moving target surface to clean the target surface. The seal contacts the target surface on an upstream side of a position where the cleaning member contacts the target surface in a surface movement direction of the target surface. The conveyor conveys foreign substances removed from the target surface by the cleaning member. The stirrer stirs the removed foreign substances. The contact stopper prevents the stirrer from contacting the target surface between the cleaning member and the seal.

### Second Aspect

In the cleaning device (e.g., the belt cleaner 10) according to the first aspect, the stirrer (e.g., the stirrer 34) contacts the driven conveyor (e.g., the conveying screw 33) to displace. The stirrer contacts the contact stopper (e.g., the contact stopper 36) when the stirrer is displaced, so that the stirrer does not contact the target surface.

### Third Aspect

In the cleaning device (e.g., the belt cleaner 10) according to the first aspect, the contact stopper (e.g., the contact stopper 36) contacts the cleaning member (e.g., the cleaning blade 31) when the stirrer (e.g., the stirrer 34) contacts the contact stopper, so that the contact stopper does not contact the target surface.

### Fourth Aspect

In the cleaning device (e.g., the belt cleaner 10) according to the first aspect, the contact stopper (e.g., the contact stopper 36) contacts the seal (e.g., the seal 32) when the stirrer (e.g., the stirrer 34) contacts the contact stopper, so that the contact stopper does not contact the target surface.

### Fifth Aspect

In the cleaning device (e.g., the belt cleaner 10) according to the first aspect, the contact stopper (e.g., the contact stopper 36) bends in a direction approaching the target surface when the stirrer (e.g., the stirrer 34) contacts the contact stopper.

### Sixth Aspect

In the cleaning device (e.g., the belt cleaner 10) according any one of the first to fifth aspects, the stirrer (e.g., the stirrer 34) has a plurality of projections (e.g., the projections 345) provided at intervals from each other in a conveyance direction in which the foreign substances are conveyed by the conveyor (e.g., the conveying screw 33).

### Seventh Aspect

In the cleaning device (e.g., the belt cleaner 10) according any one of the first to sixth aspects, the contact stopper (e.g., the contact stopper 36) has a plurality of projections (e.g., the projections 365) provided at intervals from each other in a conveyance direction in which the foreign substances are conveyed by the conveyor (e.g., the conveying screw 33).

### Eighth Aspect

An image forming apparatus (e.g., the image forming apparatus 1000) including the cleaning device (e.g., the belt cleaner 10) according to any one of the first to seventh aspects.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A cleaning device comprising:
a cleaning member to:
contact a target surface of a target moving in a first direction at a first position; and
remove foreign substances from the target surface to clean the target surface;
a seal contacting the target surface at a second position upstream from the first position in the first direction;
a conveyor to convey the foreign substances outside the cleaning device;
a stirrer to stir the foreign substances removed from the target surface; and
a contact stopper disposed between the stirrer and the target surface in a second direction intersecting the first direction to restrict contact between the stirrer and the target surface.

2. The cleaning device according to claim 1,
wherein the stirrer contacts the conveyor driven to rotate to displace in the second direction, and
the stirrer contacts the contact stopper in response to a displacement of the stirrer.

3. The cleaning device according to claim 1,
wherein the cleaning member is disposed between the contact stopper and the target surface in the second direction,
the seal is disposed between the contact stopper and the target surface in the second direction, and
the contact stopper contacts the cleaning member and the seal in response to contact between the stirrer and the contact stopper.

4. The cleaning device according to claim 1,
wherein the seal is disposed between the contact stopper and the target surface in the second direction, and
the contact stopper contacts the seal in response to contact between the stirrer and the contact stopper.

5. The cleaning device according to claim 1,
wherein the contact stopper is bent toward the target surface in the second direction in response to a contact between the stirrer and the contact stopper.

6. The cleaning device according to claim 1,
wherein the conveyor includes a screw to convey the foreign substances in a third direction intersecting the first direction and the second direction, and
the stirrer has multiple projections arranged at intervals in the third direction.

7. The cleaning device according to claim 1,
wherein the conveyor includes a screw to convey the foreign substances in a third direction intersecting the first direction and the second direction, and
the contact stopper has multiple projections arranged at intervals in the third direction.

8. An image forming apparatus comprising the cleaning device according to claim 1.

9. The cleaning device according to claim 1,
wherein the seal has a first tip portion inclined relative to the target surface and facing in the first direction, and
the cleaning member has a second tip portion inclined relative to the target surface and facing in a counter direction opposite to the first direction.

10. The cleaning device according to claim 1,
wherein the stirrer has an elastically deformable sheet including:
a fixed portion at a rear end of the stirrer; and
a bent portion at a leading end of the stirrer,
the bent portion is bent at a plurality of positions, and the bent portion includes:
a first portion bent in a direction from the fixed portion toward the conveyor and away from the target surface; and
a second portion closer to the leading end than the first portion and bent in a direction from a leading end of the first portion toward the target surface and away from the conveyor.

11. The cleaning device according to claim 1,
wherein the cleaning member includes a cleaning blade.

12. The cleaning device according to claim 1,
wherein the cleaning member includes a rotary brush.
